(19) United States
(12) Patent Application Publication
(10) Pub. No.: US 2025/0337071 A1
(43) Pub. Date: Oct. 30, 2025

(54) BATTERY SYSTEM, ELECTRIC VEHICLE AND METHOD FOR ASSEMBLING THE BATTERY SYSTEM

(71) Applicant: SAMSUNG SDI CO., LTD., Yongin-si (KR)

(72) Inventors: Michael NADERER, Deutschlandsberg (AT); Fritz HARING, Bruck an der Mur (AT)

(21) Appl. No.: 18/813,929

(22) Filed: Aug. 23, 2024

(30) Foreign Application Priority Data
Apr. 26, 2024 (EP) 24172660.3

(51) Int. Cl. H01M 50/233; H01M 10/658; H01M 50/222; H01M 50/227; H01M 50/342

(52) U.S. Cl. CPC H01M 50/233; H01M 10/658; H01M 50/222; H01M 50/227; H01M 50/3425; H01M 2200/20

(57) ABSTRACT

A battery system includes: a battery pack including a plurality of battery cells, each having a pair of electrode terminals and a venting valve at a terminal side thereof, the terminal side of each of the battery cells facing a first side of the battery pack in a z-direction; a cell contacting unit (CCU) carrier on the terminal side of each of the battery cells; and a heat resistant cell protection cover arranged between the CCU carrier and the battery cells. The heat resistant cell protection cover covering the venting valves of the battery cells and being configured to rupture if venting products are ejected through a venting valve from an inside of one of the battery cells.

### CROSS-REFERENCE TO RELATED APPLICATION

The present application claims priority to and the benefit of European Patent Application No. 24172660.3, filed on Apr. 26, 2024, in the European Patent Office, the entire disclosure of which is incorporated herein by reference.

### BACKGROUND

### 1. Field

Aspects of embodiments of the present disclosure relate to a battery system, an electric vehicle including the battery system, and a method for assembling the battery system.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle “BEV”) or may include a combination of an electric motor and, for example, a conventional combustion engine (a so-called Plugin Hybrid Electric Vehicle “PHEV”). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (e.g., is accommodated in) a casing, and electrode terminals, which are positioned on the outside of the casing, establish an electrically conductive connection to the electrodes. The casing may have, for example, a cylindrical or rectangular shape.

A battery module is formed of a plurality of battery cells connected together in series or in parallel. For example, the battery module is formed by interconnecting the electrode terminals of the plurality of battery cells, in a number and configuration depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or respectively the battery cells, may be configured in a series, parallel, or a mixture of both to provide the desired voltage, capacity, and/or power density. Components of a battery pack include the individual battery modules and interconnects, which provide electrical conductivity between the battery modules.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the energy stored is released very suddenly. In extreme cases, thermal runaway can cause battery cells to explode and start a fire. In minor cases, it can cause battery cells to be damaged beyond repair.

When a battery cell is heated above a critical temperature (e.g., above about 150° C.) the battery cell can transition into thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is therefore flammable and potentially toxic. The vented gas also causes gas-pressure to increase inside the battery pack. In the worst case, the high temperatures lead to the process (e.g., the thermal runaway) spreading to neighboring cells and a fire in the battery pack. At this stage, the fire is difficult to extinguish.

A conventional venting concept for a battery is to let the venting gas stream discharged by the battery cell(s) expand into the battery housing and escape through a housing venting valve to the outside (e.g., to the environment of the battery housing). The venting gas stream thereby heats up the components inside the battery housing, such as the other battery cells. For example, particles from the venting gas stream may deposit onto the battery cells, which may lead to thermal propagation and may incite thermal runaway in adjacent battery cells. To protect the battery cells from this, a cover element may be provided covering the battery cells at their venting or terminal side.

Such a cover element may have venting openings in the form of through-holes that are aligned with the venting exits of the battery cells to let the venting gas stream pass through the cover element in case of a thermal runaway of one of the covered battery cells. After passing through the cover element, particles of the discharged venting gas stream may deposit onto the cover element. Thereby, however, particles of the venting gas stream may pass through another venting opening in the cover element that is aligned with the venting exit of one of the battery cells and, thus, may enter another battery cell. This may exacerbate thermal propagation to the other battery cell and, in the worst case, incite a thermal runaway in the other battery cell.

To address this problem, a top cover of the battery cells may be provided with a thermal shield layer protecting against the hot gas flow and ejected particles during venting of a battery cell in case of thermal runaway. This shielding material should have a suitable thermal stability against temperatures above about 500° C. (and above about 600° C. for about 10 seconds or less) and have low mechanical stability to ensure proper venting without blocking the vent gas flow.

However, the application of the additional thermal shield layers onto the battery cells during assembly of the battery packs is cumbersome and can hardly be applied in an industrially standardized way, such as by handling with vacuum.

### SUMMARY

Embodiments of the present disclosure provide a simplified battery system that more securely handles a thermal runaway of one or more of its battery cells.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes: a plurality of battery cells, each having a pair of electrode terminals and a venting valve at a terminal side thereof, the terminal side of each of the battery cells facing a first side of the battery pack in a z-direction; a cell contacting unit (CCU) carrier on the terminal side of each of the battery cells; and a heat resistant cell protection cover arranged between the CCU carrier and the battery cells. The heat resistant cell protection cover covers the venting valves of the battery cells and is configured to rupture if venting products are ejected through a venting valve from an inside of one of the battery cells.

According to an embodiment of the present disclosure, the heat resistant cell protection cover may be configured to rupture at a pressure of more than 10 bar.

According to an embodiment of the present disclosure, the CCU carrier may include a reinforcing structure providing mechanical stability in the z-direction.

According to an embodiment of the present disclosure, the reinforcing structure may be a honeycomb structure.

According to an embodiment of the present disclosure, the reinforcing structure may be on a side of the CCU carrier opposite to the heat resistant cell protection cover.

According to an embodiment of the present disclosure, the CCU carrier and the heat resistant cell protection cover have a combined thickness in a range of 5 mm to 8 mm in the z-direction.

According to an embodiment of the present disclosure, the heat resistant cell protection cover may be directly arranged on and/or attached to the CCU carrier.

According to an embodiment of the present disclosure, the heat resistant cell protection cover may include an elastic material and may have a thickness to provide tolerance compensation caused by different heights of the battery cells in the z-direction.

According to an embodiment of the present disclosure, the venting valve of each of the battery cells may be arranged between the electrode terminals of the respective battery cell, and the CCU carrier and the heat resistant cell protection cover may be sized to be arranged in an area of the terminal sides of the battery cells between the electrode terminals of the battery cells. According to another embodiment, the CCU carrier and the heat resistant cell protection cover may have openings corresponding to the electrode terminals.

According to an embodiment of the present disclosure, the CCU carrier may include a ceramic and/or a high melting polymer compound.

According to an embodiment of the present disclosure, the high melting polymer compound may be a glass-reinforced epoxy laminate, polyamide, polyimide, or a silicon resin.

According to an embodiment of the present disclosure, the heat resistant cell protection cover may include inorganic fibers, an organic material, and/or an aerogel.

According to an embodiment of the present disclosure, the inorganic fibers may be encapsulated rock or glass wool, and/or the organic material may be polyamide, polyimide, or a silicon resin.

According to another embodiment of the present disclosure, an electric vehicle includes the battery system as described above.

According to another embodiment of the present disclosure, a method for assembling a battery system includes: providing a battery pack including a plurality of battery cells, each having a pair of electrode terminals and a venting valve at a terminal side of the battery cells, the terminal side of each of the battery cells facing a first side of the battery pack in a z-direction; providing a cell contacting unit (CCU) carrier and a heat resistant cell protection cover, the heat resistant cell protection cover being configured to rupture if venting products are ejected through a venting valve from an inside of one of the battery cells; and arranging the CCU carrier on the terminal side of each of the battery cells of the battery pack such that the heat resistant cell protection cover is arranged between the CCU carrier and the battery cells and covers the venting valves of the battery cells.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective top view of a battery system according to an embodiment of the present disclosure.

FIG. 2 is a schematic perspective bottom view of a cell contacting unit carrier and a heat resistance cell protection cover of the battery system shown in FIG. 1.

FIG. 3 is a schematic flow chart describing steps of a method for assembling the battery system shown in FIG. 1 according to an embodiment.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, such as on a PCB or another kind of circuit carrier. The conducting elements may include metallization, for example, surface metallizations and/or pins, and/or may include conductive polymers or ceramics. Further electrical energy might be transmitted via wireless connections, such as by using electromagnetic radiation and/or light.

According to one embodiment of the present disclosure, a battery system includes a battery pack, and the battery pack includes a plurality of battery cells. The battery cells of the plurality of battery cells each have a pair of electrode terminals and a venting valve disposed at a terminal side of the battery cells. The terminal side of each of the battery cells faces a first side of the battery pack in a z-direction. Each venting valve may be configured to allow for a venting gas stream to be discharged from the respective battery cell during a thermal runaway of the corresponding battery cell. For example, the venting valves may open (e.g., may burst) upon a reference (or predetermined) pressure being exceeded. The venting valves are provided at or in venting exits, such as a venting hole (or venting opening), in the battery cells. The battery cells may be accommodated inside a battery housing of the battery pack and/or the battery system. The battery cells may be arranged, or stacked, along a stacking direction to form one or more cell stacks. The battery cells may be interconnected via an electrical connector, for example, busbars, contacting respective electrode terminals of the battery cells to form one or more battery modules/battery packs. The battery cells may be arranged to form one or more battery packs. In a battery pack, the battery cells may be electrically interconnected, for example, in series and/or in parallel. Multiple of these battery packs may form a battery module. The battery cells may be, for example, prismatic cells.

The battery system further includes a cell contacting unit (CCU) carrier disposed on the terminal side of each of the battery cells. The CCU carrier may be rectangular. The CCU carrier, however, is not limited to the rectangular shape. The CCU carrier may have any suitable shape to fit to the battery pack, for example, a square or ellipsoidal shape. The CCU carrier may include via electrical connectors, for example, busbars, contacting respective electrode terminals of the battery cells to form one or more battery modules/battery packs. The CCU carrier may further include measuring lines for transmitting at least one physical property of the battery cells. The physical property may be, for example, voltage, current, or temperature of the battery cells. The CCU carrier may be attached to the terminal side of each of the battery cells, for example, by a fixation element, such as a screw, bolt, or an adhesive. For example, the CCU carrier may be directly attached to the terminal side of each of the battery cells. The CCU carrier may have openings aligned with the venting valves to form venting channels for conducting a hot venting gas stream discharged by a battery cell, for example, during a thermal runaway, to the outside of the battery pack.

The battery system further includes a heat resistant cell protection cover arranged between the CCU carrier and the battery cells. The heat resistant cell protection cover provides additional heat protection, for example, during a thermal runaway. The hot venting gas stream may heat up the components inside the battery housing, such as the other battery cells. For example, particles from the venting gas stream may deposit onto the battery cells, which may lead to thermal propagation and may incite thermal runaway in adjacent battery cells. To protect the battery cells, the heat resistant cell protection cover may be provided covering the battery cells at their terminal side, for example, the heat resistant cell protection cover may be arranged such that it covers the plurality of battery cells at their terminal sides. For example, the heat resistant cell protection cover may cover the top side of the battery cells. The heat resistant insulation sheet may also cover the CCU carrier openings in the CCU carrier. In some embodiments, the heat resistant cell protection cover may cover all of the battery cells of the plurality of battery cells, for example, the heat resistant cell protection cover may extend over the terminal sides of all of the battery cells of the plurality of battery cells. The heat resistant cell protection cover may be attached to the terminal side of each of the battery cells by, for example, a fixation element, such as a screw, bolt, or an adhesive.

The heat resistant cell protection cover further covers the venting valves of the battery cells. The heat resistant cell protection cover is configured to rupture if venting products are ejected through a venting valve from an inside of one of the battery cells. For example, the heat resistant cell protection cover rips apart or ruptures due to the discharged venting gas from a covered battery cell during a thermal runaway. Due to the rupture of the heat resistant cell protection cover, the venting gas stream can pass through the CCU carrier without being blocked by the heat resistant cell protection cover. After passing through the CCU carrier, particles of the discharged venting gas stream may deposit onto the CCU carrier and the heat resistant cell protection cover covering the venting valves of the other battery cells. Accordingly, the heat resistant cell protection cover may prevent particles of the venting gas stream from passing through the venting exits of the other battery cells and, thus, the particles cannot enter the other battery cells. Therefore, thermal propagation to the other battery cells and the incitation of a thermal runaway in the other battery cells may be avoided or at least greatly reduced.

According to one embodiment, the heat resistant cell protection cover is configured to rupture at a pressure of more than 10 bar. For example, the heat resistant cell protection cover is relatively thin or mechanically tearable so that the pressure of the venting stream, which occurs when the venting valve opens due to a thermal runaway, pushes through (e.g., bursts) the heat resistant cell protection cover. The pressure of the discharged venting stream may differ between different types, shapes, and/or forms of the correspondingly used battery cells. Therefore, the heat resistant cell protection cover may be configured to rupture at a pressure applied thereon that corresponds to a characteristic pressure of the venting stream of the corresponding type, shape, and/or form of the corresponding battery cell during a thermal runaway.

According to another embodiment, the CCU carrier includes a reinforcing structure, such as reinforcing ribs, providing mechanical stability in the z-direction. Mechanical stability of the CCU carrier ensures proper venting of the discharged venting stream occurred during a thermal runaway event. Thus, collapsing of the structure of the CCU carrier due to the occurring pressure and blockage of the venting stream can be prevented by the reinforcing structure. The sections of the CCU carrier covering the venting valves of the battery cells, for example, the openings in the CCU carrier, may be spaced apart with respect to the reinforcing structure to let the venting stream pass through the CCU carrier without obstruction.

According to another embodiment, the reinforcing structure is a honeycomb structure. The honeycomb structure provides excellent mechanical stability. Honeycomb structures are structures that have the geometry of a honeycomb, which reduces the amount of material necessary and to provide minimal weight and minimal material cost. The honeycomb structure includes an array of hollow cells formed between thin vertical walls, for example, walls extending in the z-direction. The hollow cells may be columnar or hexagonal in shape. The honeycombs, for example, the hollow cells, can also act as deposit zones for ejected material, thereby reducing overall contamination of the battery pack.

According to another embodiment, the reinforcing structure is arranged on a (first) side of the CCU carrier opposite to the heat resistant cell protection cover. The reinforcing structure may be arranged directly on the (first) side of the CCU carrier opposite to the heat resistant cell protection cover. Because the reinforcing structure is located on the (first) side of the CCU carrier opposite to the heat resistant cell protection cover, the reinforcing structure may be protected from the venting products of the battery cell, and the heat resistant cell protection cover can be easily arranged on or attached to the other side (second) side of the CCU carrier. For example, the CCU carrier may have a smooth surface on the (second) side of the heat resistant cell protection cover.

According to another embodiment, the CCU carrier and the heat resistant cell protection cover have a combined thickness in a range of about 5 mm to about 8 mm in the z-direction. Even though the temperature of the venting products may be too high for the heat resistant cell protection cover, because the venting event generally lasts only a few seconds, the heat input is not sufficient to completely decompose the

CCU carrier over its entire thickness. Thus, although the CCU carrier and the heat resistant cell protection cover may be partially decomposed, for example, for a few millimeters, sufficient thickness thereof remains to ensure insulation of the battery cells, for example, against electrically conducting particles in the venting gas.

According to another embodiment, the heat resistant cell protection cover is directly arranged on and/or attached to the CCU carrier. For example, the heat resistant cell protection cover is directly attached to the CCU carrier. For example, the heat resistant cell protection cover and the CCU carrier may be preassembled. For example, the heat resistant cell protection cover and the CCU carrier may be combined in advance, that is, prior to assembly of the battery pack, to simplify the manufacturing of the battery pack. Accordingly, placement of the heat resistant cell protection cover during the assembly of the battery pack may be omitted. For example, the heat resistant cell protection cover and the CCU carrier may be formed as a compound. The heat resistant cell protection cover may be applied directly onto the CCU carrier including the reinforcing structure, for example, the honeycomb structure.

According to another embodiment, the heat resistant cell protection cover includes an elastic material and has a thickness sufficient to provide tolerance compensation caused by different heights of the battery cells in the z-direction. A battery cell having an increased height in the z-direction may come into contact with the heat resistant cell protection cover and may press into it, which may generally lead to rupture of the heat resistant cell protection cover. However, such a rupture may be prevented because the heat resistant cell protection cover is configured not to rupture based on tolerance related differences of the battery cells in the z-direction. Furthermore, because the heat resistant cell protection cover is arranged between the CCU carrier and the battery cells, its elasticity facilitates the fixation of the CCU carrier to the battery cells in z-direction. For example, the heat resistant cell protection cover may ensure tolerance compensation caused by battery cell and manufacturing tolerances to ensure proper fixation in z-direction.

According to another embodiment, the venting valve of each of the battery cells is arranged between the electrode terminals of the respective battery cell. The CCU carrier and the heat resistant cell protection cover are sized to be arranged in an area of the terminal sides of the battery cells between the electrode terminals of the battery cells or may have openings for (e.g., corresponding to) the electrode terminals. For example, the CCU carrier and the heat resistant cell protection cover fit into the area(s) between the electrode terminals of the battery cells and do not extend over or above the electrode terminals.

According to another embodiment, the CCU carrier includes (or consists of) a ceramic and/or a high melting polymer compound. These materials provide flame retardancy, high thermal stability, and low ageing properties.

According to another embodiment, the high melting polymer compound is a FR-4 (a glass-reinforced epoxy laminate), a polyamide, a polyimide, or a silicon resin. These materials have sufficient stability over the general duration of a venting event, for example, for around or less than 20 seconds. FR-4 is a NEMA grade designation for glass-reinforced epoxy laminate material. FR-4 is a composite material composed of woven fiberglass cloth with an epoxy resin binder and is flame resistant.

According to another embodiment, the heat resistant cell protection cover includes or consists of inorganic fibers, an organic material, and/or an aerogel. These materials provide flame retardancy, high thermal stability, and low ageing properties. Aerogel, which is a synthetic porous ultralight material derived from a gel, easily rips apart during venting and does not deflect the venting gas flow but provides excellent thermal insulation against hot venting gas particles.

According to another embodiment, the inorganic fibers are encapsulated rock or glass wool, and/or the organic material is polyamide, polyimide, or a silicon resin. These materials are good candidates that can be configured to rupture if venting products are ejected through a venting valve from an inside of one of the battery cells.

Embodiments of the present disclosure also provide an electric vehicle including a battery system as described herein, for example, as a traction battery.

Further, embodiments of the present disclosure also provide a method for assembling a battery system, namely, the above-described battery system.

According to one step of the method, a battery pack including a plurality of battery cells, each having a pair of electrode terminals and a venting valve disposed at a terminal side of the battery cells is provided. The terminal side of each of the battery cells faces a first side of the battery pack in a z-direction.

According to another step of the method, a CCU carrier and a heat resistant cell protection cover, such as the above-described CCU carrier and heat resistant cell protection cover, are provided. The heat resistant cell protection cover is configured to rupture if venting products are ejected through a venting valve from an inside of one of the battery cells.

According to another step, the CCU carrier is disposed on the terminal side of each of the battery cells of the battery pack such that the heat resistant cell protection cover is arranged between the CCU carrier and the battery cells and such that the heat resistant cell protection cover covers the venting valves of the battery cells.

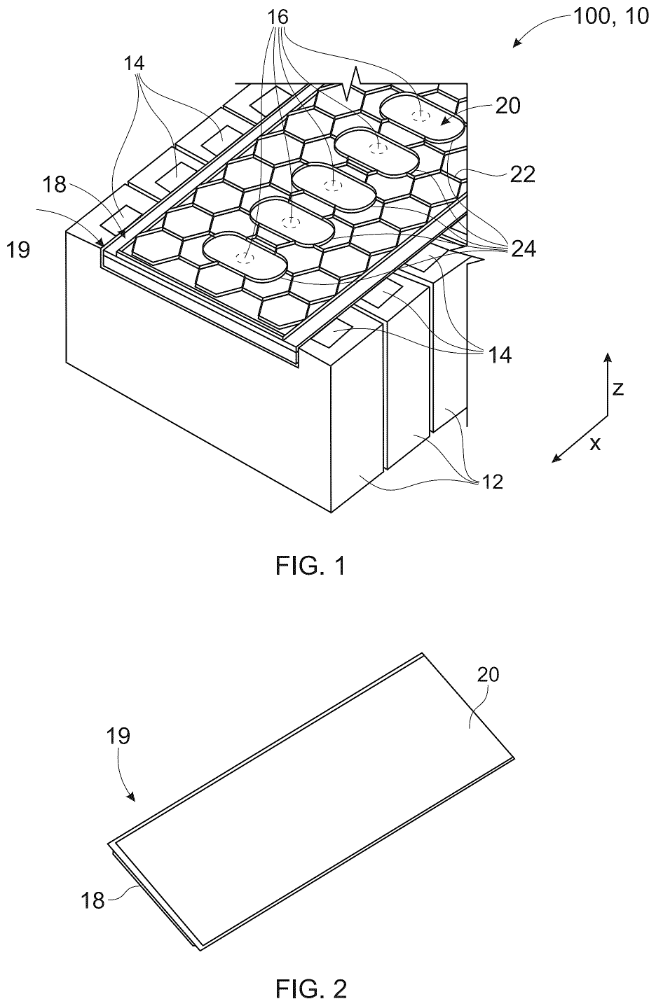

FIG. 1 is a schematic perspective top view of a battery system 100 according to an embodiment. FIG. 2 illustrates a schematic perspective bottom view of a cell contacting unit assembly 19 shown in FIG. 1.

The battery system 100 includes a battery pack 10 including a plurality of battery cells 12. For brevity reasons, the figures depict an example of the battery pack 10 including four battery cells 12. However, the number of battery cells 12 is an example, and the battery pack 10 may include more or less than four battery cells 12. For example, the battery pack 10 may include 2, 3, 5, 6 or any suitable number of battery cells 12. In the illustrated embodiment, the battery cells 12 are prismatic cells stacked along a stacking direction x to form a battery cell stack (see, e.g., FIG. 1).

Each of the battery cells 12 has a pair of electrode terminals 14 and a venting valve 16 disposed therebetween at a terminal side of the battery cells 12. The terminal side of each of the battery cells 12 faces a first side of the battery pack 10 in a z-direction. In FIG. 1, the z-direction corresponds to the vertical direction of the image plane, that is, from up to down or vice versa.

The battery system 100 further includes a cell contacting unit (CCU) assembly 19 disposed on the terminal side of each of the battery cells 12. The CCU assembly 19 includes a CCU carrier 18 and a heat resistant cell protection 20. The CCU carrier 18 and the heat resistant cell protection 20 may be integrated to provide mechanical and structural integrity as well as heat resistance within a single component in the CCU assembly 19. The heat resistant cell protection cover 20 is arranged between the CCU carrier 18 and the battery cells 12. The heat resistant cell protection cover 20 is arranged to cover the battery cells 12 at their terminal sides. For example, the heat resistant cell protection cover 20 covers the top side of the battery cells 12. The heat resistant cell protection cover 20 may extend over the terminal sides of the battery cells 12. Because the heat resistant cell protection cover 20 is arranged between the CCU carrier 18 and the battery cells 12, the CCU carrier 18 may be protected from direct venting gas discharged from the venting valves 16 of the battery cells 12 in case of a thermal runaway.

The heat resistant cell protection cover 20 is arranged to cover the venting valves 16 of each of the battery cells 12. The CCU carrier 18 and the heat resistant cell protection cover 20 are sized to be arranged in an area of the terminal sides of the battery cells 12 between the electrode terminals 14 of the battery cells 12. For example, the CCU carrier 18 and the heat resistant cell protection cover 20 fit into the area(s) between the electrode terminals 14 of the battery cells 12 but do not extend over or above the electrode terminals 14. Thus, a compact design of the battery pack 10 may be achieved.

Furthermore, the heat resistant cell protection cover 20 is configured to rupture (e.g., burst) if venting products are ejected through a venting valve 16 from an inside of one of the battery cells 12. For example, the heat resistant cell protection cover 20 ruptures if a pressure of more than about 10 bar is applied thereto. In other words, the heat resistant cell protection cover 20 rips apart or ruptures due to the discharged venting gas from a covered battery cell 12 during a thermal runaway. Due to the rupture of the heat resistant cell protection cover 20, the venting gas stream can pass through the CCU carrier 18 without being blocked by the heat resistant cell protection cover 20. After passing through the CCU carrier 18, particles of the discharged venting gas stream may deposit onto the CCU carrier 18 and the heat resistant cell protection cover 20 covering the venting valves 16 of the other battery cells 12. Accordingly, the heat resistant cell protection cover 20 prevents particles of the venting gas stream from passing through the venting valves 16 of the other battery cells 12 and, thus, the particles cannot enter the other battery cells 12. Therefore, thermal propagation to the other battery cells 12 and incitation of a thermal runaway in the other battery cells 12 can be avoided or at least greatly reduced.

As shown in FIG. 1, the heat resistant cell protection cover 20 is arranged directly between the CCU carrier 18 and the battery cells 12, for example, the heat resistant cell protection cover 20 is in direct contact with the CCU carrier 18 and the battery cells 12. However, the heat resistant cell protection cover 20 is not limited thereto. The battery system 100 may further include additional layers that are arranged between the heat resistant cell protection cover 20 and the CCU carrier 18 and/or the battery cells 12 as well. For example, the heat resistant cell protection cover 20 may be in indirect contact with the CCU carrier 18 and/or the battery cells 12.

The CCU carrier 18 further includes a reinforcing structure 22, such as reinforcing ribs, to provide mechanical stability in the z-direction and to form CCU carrier openings 24 aligned with the venting valves 16 (e.g., one opening 24 for each venting valve 16 of the battery cells 12) to form venting channels. For example, the sections of the CCU carrier 18 covering the venting valves 16 of the battery cells 12 are spaced apart with respect to the reinforcing structure 22 to let the venting stream pass through the CCU carrier 18 without obstruction. Sufficient mechanical stability of the CCU carrier 18 ensures proper venting of the discharged venting stream during a thermal runaway event. Thus, collapse of the structure of the CCU carrier 18 due to the pressure and blocking of the venting stream can be prevented by the reinforcing structure 22. For example, as shown in FIG. 1, the reinforcing structure 22 is a honeycomb structure. The honeycomb structure includes an array of hollow cells formed between thin vertical walls (e.g., walls extending in the z-direction). The hollow cells are hexagonal in shape. The hollow cells can also act as deposit zones for ejected material, thereby reducing overall contamination of the battery pack 10.

The reinforcing structure 22 is arranged on a first side of the CCU carrier 18 opposite to a second side of the CCU carrier 18, on which the heat resistant cell protection cover 20 is arranged. The first side of the CCU carrier 18 faces the first side of the battery pack 10 along the z-direction. For example, the reinforcing structure 22 faces away from the battery cells 12. As shown in FIG. 2, the heat resistant cell protection cover 20 is arranged on the second side of the CCU carrier 18 facing the battery cells 12. The surface of the CCU carrier 18 on the second side thereof is smooth, thereby facilitating attachment of the heat resistant cell protection cover 20 to the CCU carrier 18. For example, the heat resistant cell protection cover 20 and the CCU carrier 18 may be preassembled. For example, the heat resistant cell protection cover 20 and the CCU carrier 18 may be combined in advance, that is, prior to assembly of the battery pack 10 to simplify the manufacturing of the battery pack 10 and/or the battery system 100. Accordingly, an additional step of placing the heat resistant cell protection cover 20 during the assembly of the battery pack 10 may be omitted.

The shape of the heat resistant cell protection cover 20 may correspond to the shape of the CCU carrier 18 so that substantially the entire second side of the CCU carrier 18 facing the battery cells 12 is covered by the heat resistant cell protection cover 20. The CCU carrier 18 and/or the heat resistant cell protection cover 20 may be rectangular. The CCU carrier 18 and/or the heat resistant cell protection cover 20, however, are not limited to the rectangular shape. The CCU carrier 18 and/or the heat resistant cell protection cover 20 may have any other suitable shape that fits to the battery pack 10, for example, a square or ellipsoidal shape.

The CCU carrier 18 and the heat resistant cell protection cover 20 have a combined thickness of about 6 mm in the z-direction. However, the CCU carrier 18 and the heat resistant cell protection cover 20 may have a combined thickness in a range of about 5 mm to about 8 mm in the z-direction. Even though the temperature of the venting products may be too high for the heat resistant cell protection cover 20, because to the venting event lasts only a few seconds most of the time, the heat input is not sufficient to completely decompose the CCU carrier 18 over its entire thickness. Thus, although the CCU carrier 18 and the heat resistant cell protection cover 20 may be partially decomposed, for example, for a few millimeters, there is still enough thickness remaining to ensure insulation of the battery cells 12 against electrically conducting particles in the venting gas.

The CCU carrier 18 includes (or consists of) a high melting polymer compound, such as a FR-4 (a glass-reinforced epoxy laminate), a polyamide, a polyimide, or a silicon resin. However, the CCU carrier 18 may also include or consist of a ceramic. These materials provide flame retardancy, high thermal stability, and low ageing properties.

The heat resistant cell protection cover 20 may include (or may consist of) an aerogel. Aerogel is a synthetic porous ultralight material derived from a gel, easily rips apart during venting, and does not deflect the venting gas flow but provides excellent thermal insulation against hot venting gas particles. However, the heat resistant cell protection cover 20 may also include (or consist of) inorganic fibers and/or organic fibers. These materials provide flame retardancy, high thermal stability, and low ageing properties.

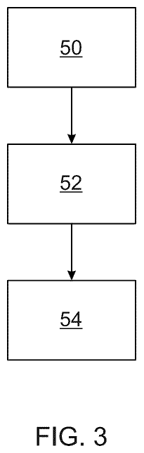

FIG. 3 is a schematic flow chart describing steps of a method for assembling the battery system 100 shown in FIG. 1 according to an embodiment.

According to a first step 50, the above-described battery pack 10 is provided. For example, a battery pack 10 including a plurality of battery cells 12, each having a pair of electrode terminals 14 and a venting valve 16 disposed at a terminal side of the battery cells 12, in which the terminal side of each of the battery cells 12 faces a first side of the battery pack 10 in a z-direction, is provided.

According to a second step 52 of the method, a CCU carrier 18 and a heat resistant cell protection cover 20 are provided. The CCU carrier 18 and the heat resistant cell protection cover 20 are the above-described CCU carrier 18 and heat resistant cell protection cover 20. The heat resistant cell protection cover 20 is configured to rupture if venting products are ejected through a venting valve 16 from an inside of one of the battery cells 12.

According to a third step 54 of the method, the CCU carrier 18 is disposed on the terminal side of each of the battery cells 12 of the battery pack 10 such that the heat resistant cell protection cover 20 is arranged between the CCU carrier 18 and the battery cells 12 and such that the heat resistant cell protection cover 20 covers the venting valves 16 of the battery cells 12.

### SOME REFERENCE SYMBOLS

10 battery pack
12 battery cells
14 electrode terminals
16 venting valve
18 cell contacting unit carrier
19 cell contacting unit assembly
20 heat resistant cell protection cover
22 reinforcing structure
24 CCU carrier openings
50 first method step
52 second method step
54 third method step
100 battery system

What is claimed is:

1. A battery system comprising:
a battery pack comprising a plurality of battery cells, each having a pair of electrode terminals and a venting valve at a terminal side thereof, the terminal side of each of the battery cells facing a first side of the battery pack in a z-direction;
a cell contacting unit (CCU) carrier on the terminal side of each of the battery cells; and
a heat resistant cell protection cover arranged between the CCU carrier and the battery cells, the heat resistant cell protection cover covering the venting valves of the battery cells and being configured to rupture if venting products are ejected through a venting valve from an inside of one of the battery cells.

2. The battery system as claimed in claim 1, wherein the heat resistant cell protection cover is configured to rupture at a pressure of more than 10 bar.

3. The battery system as claimed in claim 1, wherein the CCU carrier comprises a reinforcing structure providing mechanical stability in the z-direction.

4. The battery system as claimed in claim 3, wherein the reinforcing structure is a honeycomb structure.

5. The battery system as claimed in claim 3, wherein the reinforcing structure is on a side of the CCU carrier opposite to the heat resistant cell protection cover.

6. The battery system as claimed in claim 1, wherein the CCU carrier and the heat resistant cell protection cover have a combined thickness in a range of 5 mm to 8 mm in the z-direction.

7. The battery system as claimed in claim 1, wherein the heat resistant cell protection cover is directly arranged on the CCU carrier.

8. The battery system as claimed in claim 1, wherein the heat resistant cell protection cover comprises an elastic material and has a thickness sufficient to compensate for a tolerance caused by different heights of the battery cells in the z-direction.

9. The battery system as claimed in claim 1, wherein the venting valve of each of the battery cells is arranged between the electrode terminals of the respective battery cell, and
wherein the CCU carrier and the heat resistant cell protection cover are sized to be arranged in an area of the terminal sides of the battery cells between the electrode terminals of the battery cells.

10. The battery system as claimed in claim 1, wherein the venting valve of each of the battery cells is arranged between the electrode terminals of the respective battery cell, and
wherein the CCU carrier and the heat resistant cell protection cover have openings corresponding to the electrode terminals.

11. The battery system as claimed in claim 1, wherein the CCU carrier comprises a ceramic.

12. The battery system as claimed in claim 1, wherein the CCU carrier comprises a high melting polymer compound.

13. The battery system as claimed in claim 12, wherein the high melting polymer compound is a glass-reinforced epoxy laminate, polyamide, polyimide, or a silicon resin.

14. The battery system as claimed in claim 1, wherein the heat resistant cell protection cover comprises inorganic fibers, an organic material, and/or an aerogel.

15. The battery system as claimed in claim 14, wherein the inorganic fibers are encapsulated rock or glass wool, and/or the organic material is polyamide, polyimide, or a silicon resin.

16. An electric vehicle comprising the battery system as claimed in claim 1.

17. A method for assembling a battery system, the method comprising:
providing a battery pack comprising a plurality of battery cells, each having a pair of electrode terminals and a venting valve at a terminal side thereof, the terminal side of each of the battery cells facing a first side of the battery pack in a z-direction;
providing a cell contacting unit (CCU) carrier and a heat resistant cell protection cover, the heat resistant cell protection cover being configured to rupture if venting products are ejected through a venting valve from an inside of one of the battery cells; and
arranging the CCU carrier on the terminal side of each of the battery cells of the battery pack such that the heat resistant cell protection cover is arranged between the CCU carrier and the battery cells and covers the venting valves of the battery cells.
